(19) United States
(12) Patent Application Publication
(10) Pub. No.: US 2009/0187895 A1
(43) Pub. Date: Jul. 23, 2009

(54) DEVICE, METHOD, PROGRAM, AND RECORDING MEDIUM FOR CONVERTING PROGRAM

(75) Inventor: Masaaki Mineo, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/355,214

(22) Filed: Jan. 16, 2009

(30) Foreign Application Priority Data
Jan. 18, 2008 (JP) 2008-009772

(51) Int. Cl. G06F 9/44

(52) U.S. Cl. 717/136

(57) ABSTRACT

Provided is a program converting device that facilitates processing of assigning each of process units to be executed in parallel, with information (a relative priority, for example) that directs an OS or a scheduler regarding processing performance to be allocated to all or a part of the process units. The program converting device of the present invention includes: a requirement information receiving unit that receives requirement information that indicates required performance required on all or a part of an object program; a dividing unit that calculates a processing amount of each of at least one of process units executable in parallel and then divides at least a part of an input program into the process units to satisfy the required performance; and a direction information generation unit that generates an direction information file that directs, to a processor, regarding processing performance to be allocated to at least one of the divided process units.

### BACKGROUND OF THE INVENTION

(1) Field of the Invention

The present invention relates to program converting devices and methods for converting an input program described in a C language or an assembly language into an object program described in a machine language. More particularly, the present invention relates to a device, a method, a program, and a recording medium which have functions of achieving parallelization and convert a program so that performance can be automatically assured for process units such as threads that are divided from the program to be executed in parallel.

(2) Description of the Related Art

Conventional parallelizing compilers divide a parallelization executable part designated in an input program into a plurality of process units, or automatically detect such a parallelization executable part and then divides the detected part into a plurality of process units. This aims for improvement of a processing speed in parallelization.

Assurance of processing performance is important in execution environments of media processing. The assurance of processing performance means assurance of completing tasks within a predetermined time period. Programmers assign relative priorities to tasks in order to assure the processing performance. According to the relative priority, an operating system or a hardware scheduler allocates a time period to each of the tasks, which can assure performance of the tasks. Thereby, such a task with performance assurance is not influenced by any other tasks and has a priority of using the allocated time period in an execution environment, so that the processing performance is assured for the task.

In parallelization in execution environments of media processing, the assurance of processing performance is more important than improvement of a processing speed. If parallelization is performed on a task with performance assurance, the task is divided into a plurality of process units, which destroys the performance assurance. In this case, relative priorities should be assigned to the divided process units, respectively.

It is known, from Japanese Unexamined Patent Application Publication No. 2006-126977, for example, to provide a method of automatically dividing a program into designated sections as tasks, and assigning relative priorities to the sections.

In the conventional technique, a programmer assigns relative priorities to respective process units which are divided from an object program in parallelization. The relative priority should be a value by which the object program can satisfy processing performance required by the programmer. Therefore, a processing amount of each process unit needs to be calculated, and then each process unit is assigned with a relative priority depending on the calculated processing amount. However, additional processing is performed on each of process units divided in parallelization so that a parallel compiler can execute the process units in parallel. A processing amount required for the additional processing is called an overhead of the parallelization. The calculation of the processing amounts of the process units needs consideration of the overhead of the parallelization. This makes it difficult to calculate a processing amount of each process unit from a source code. A programmer has to repeat trial and error to determine relative priorities to assure the required processing performance, which takes a considerable time. In addition, the relative priorities determined by the above method can assure the required processing performance only at minimum. There is a high possibility that the relative priority has a low accuracy so that a scheduler allocates a redundant time period to the corresponding process unit due to the relative priority.

Thus, the present invention overcomes the problems of the conventional techniques as described above. It is an object of the present invention to provide a program converting device, method, program, and recording medium for improving efficiency of assigning each of at least one of process units to be executed in parallel, with information (a relative priority, for example) that directs, to an OS or a scheduler, processing performance to be allocated to a part or all of the process units.

Thus, it is another object of the present invention to provide a program converting device, method, program, and recording medium for increasing accuracy of the information that directs, to an OS or a scheduler, processing performance to be allocated to process units to be executed in parallel.

### SUMMARY OF THE INVENTION

In accordance with an aspect of the present invention for achieving the objects, there is provided a program converting device that converts an input program to an object program, said program converting device comprising: a dividing unit configured to divide at least a part of the input program into a plurality of process units which are executable in parallel; and a generation unit configured to generate direction information that directs, to a processor, processing performance to be allocated to at least one of the plurality of process units.

With the above structure, when the input program is to be converted, the program converting device can improve efficiency of assigning each of at least one of process units to be executed in parallel, with information (a relative priority, for example) that directs, to an OS or a scheduler, processing performance to be allocated to all or a part of the process units.

The dividing unit may be configured to calculate a processing amount of each of at least one of the plurality of process units, and said generation unit may be configured to generate the direction information using the processing amount calculated by said dividing unit.

With the above structure, the direction information can be generated using the processing amount calculated by the dividing unit, which makes it possible to improve efficiency of deciding the direction information for the process unit.

The program converting device may further include a receiving unit configured to receive requirement information that indicates required performance required on all or a part of the object program, wherein said dividing unit is configured to perform the dividing to satisfy the required performance indicated by the requirement information.

With the above structure, once a programmer generates the requirement information, it is possible to generate the direction information that satisfies a requirement of the programmer on all or a part of the object program. This makes it possible to improve efficiency of setting the processing performance for the process units and an accuracy of the direction information.

The dividing unit may include: a decision unit configured to decide a plurality of to-be-divided parts in the input program, the plurality of to-be-divided parts being executable in parallel; a calculation unit configured to calculate a processing amount of each of at least one of the plurality of to-be-divided parts; a determination unit configured to determine whether or not the processing amount calculated by said calculation unit satisfies the required performance indicated by the requirement information; and a dividing processing unit configured to divide the at least the part of the input program into the to-be-divided parts as the plurality of process units, when said determination unit determines that the processing amount satisfies the required performance, wherein said decision unit is configured to change the to-be-divided parts, when said determination unit determines that the processing amount does not satisfy the required performance.

With the above structure, it is possible to considerably reduce a trial and error processing of the programmer to set the processing performance to be allocated to the process units to be executed in parallel.

The dividing unit may be configured to calculate the processing amount including an overhead resulting from the dividing to the plurality of process units.

With the above structure, it is possible to generate the direction information in consideration of an overhead of parallelization, for process units which are among the plurality of process units and whose processing amounts are decided, when the input program is to be converted, based on information held by the program converting device. This makes it possible to improve an accuracy of the processing performance to be allocated to the process units to be executed in parallel.

The dividing unit may be configured to calculate the processing amount using profile information added to the input program.

With the above structure, it is possible to generate the direction information in consideration of an overhead of parallelization, for process units having processing amounts that are decided, when the input program is to be converted, based on information which the program converting device does not hold. This makes it possible to improve an accuracy of the calculated processing amounts.

The dividing unit may be configured to calculate the processing amount using hint information added to the input program.

The hint information may be regarding the number of cycles required to execute all or a part of the plurality of process units.

The hint information may be regarding a rate of (i) a processing amount of all or a part of the plurality of process units to (ii) a processing amount of all of the object program.

The hint information may be regarding a value of a variable described in the input program, the value being decided in executing the object program.

With the above structure, it is possible to shorten a time period required to calculate a processing amount of a process unit added with hint information, thereby increasing a speed of the program conversion. In addition, if the hint information is added to the process unit having a processing amount which is decided, when the input program is to be converted, based on information which the program converting device does not hold, it is possible to generate the direction information and to improve efficiency of deciding a relative priority for the process unit and an accuracy of the relative priority.

The decision unit may be configured to, when the change of the to-be-divided parts is impossible, generate and output a message notifying the impossibility.

With the above structure, without executing the object program, it is possible to confirm that the object program does not satisfy the desired processing performance. This improves efficiency of setting the direction information for each process unit.

The direction information may be regarding the number of cycles required to execute all or a part of the plurality of process units.

The direction information may be regarding a time period required to execute all or a part of the plurality of process units.

The direction information may be regarding a ratio of (i) a processing amount of all or a part of the plurality of process units to (ii) a processing amount of the object program.

The direction information may be regarding a priority assigned to each of all or a part of the plurality of process units.

The direction information may be regarding a processing amount to be allocated to all or a part of the plurality of process units.

With the above structure, it is possible to improve an accuracy of the direction information, thereby improving an accuracy of the processing performance to be allocated to the process units.

The generation unit may be configured to generate the direction information as a file.

With the above structure, a programmer can check the direction information in the file, and easily modify the direction information because the direction information is a file.

The generation unit may be configured to generate the direction information to be a part of the object program.

With the above structure, a programmer can check the direction information in the file, and easily modify the direction information. Further, if plural pieces of direction information are arranged together in the object program, a programmer can manage the pieces of direction information only by managing the object program, which makes it easy to manage a program file. Furthermore, if pieces of direction information for all or a part of process units are arranged separately in respective locations in the object program, a scheduler can retrieve the pieces of direction information when the process units in the object program are to be executed, without searching the object program. This increases a processing speed of the scheduler.

The requirement information may be a requirement for performance on at least two of the plurality of process units.

The requirement information may be regarding an upper limit of the number of cycles required to execute all or a part of the object program.

With the above structure, it is possible to improve efficiency of deciding, for process units, relative priorities which satisfy the cycle number indicated by the requirement information.

The requirement information may be regarding an upper limit of a time period required to execute all or a part of the object program.

With the above structure, it is possible to improve efficiency of deciding, for process units, relative priorities which satisfy the required processing time period.

The requirement information may be regarding an upper limit of the number of instructions for executing all or a part of the object program.

With the above structure, it is possible to improve efficiency of deciding, for process units, relative priorities which satisfy the number of instructions which is indicated by the requirement information.

The requirement information may be regarding an upper limit of a code size for executing all or a part of the object program.

With the above structure, it is possible to improve efficiency of deciding, for process units, relative priorities which satisfy the code size indicated by the requirement information.

The requirement information may be regarding an upper limit of a ratio of (i) the processing performance to be allocated to all or a part of the plurality of process units to (ii) processing performance required for the object program.

With the above structure, it is possible to improve efficiency of deciding relative priorities, so that all or a part of an object program can be executed within a range of the allocated processing performance indicated by the requirement information.

The requirement information may be regarding an upper limit of a use amount of a hardware resource used for all or the part of the object program.

With the above structure, it is possible to improve efficiency of deciding, for process units, relative priorities which satisfy the use amount of the hardware resources indicated by the requirement information.

The requirement information may be regarding information for controlling a flow of executing all or a part of the object program.

With the above structure, it is possible to improve efficiency of deciding, for process units, processing performance of executing a flow of executing all or a part of the object program.

It should be noted that the present invention can be realized not only as the program converting device including the above-described characteristic units, but also as: a program converting method including steps performed by the characteristic units of the program converting device; a compiler causing a computer to execute the characteristic units of the program converting device; and the like. Obviously, the compiler can be distributed by a recording medium such as a Compact Disc-Read Only Memory (CD-ROM) or by a transmission medium such as the Internet.

According to the present invention, direction information corresponding to processing amounts of process units to be divided for parallelization is generated, which makes it possible to improve efficiency of deciding processing performance to be allocated to each of at least one of process unit and an accuracy of the processing performance.

### FURTHER INFORMATION ABOUT TECHNICAL BACKGROUND TO THIS APPLICATION

The disclosure of Japanese Patent Application No. 2008-009772 filed on Jan. 18, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a structure of a compiler system according to an embodiment of the present invention;

FIG. 2 shows an example of an input program that has not yet been converted by the compiler system of FIG. 1;

FIG. 3 is a flowchart of processing performed by a requirement information receiving unit 2 in the compiler system of FIG. 1;

FIG. 4 is a table showing an example of a requirement information list generated by the requirement information receiving unit 2 in the compiler system of FIG. 1;

FIG. 5 is a table showing conversion expressions used to convert requirement information detected by the requirement information receiving unit 2 in the compiler system of FIG. 1;

FIG. 6 is a flowchart of processing performed by a dividing unit 3 in the compiler system of FIG. 1;

FIG. 7 is a diagram showing an example of execution of the input program of FIG. 2 which is divided into process units at Step e001 by the dividing unit 3 in the compiler system of FIG. 1;

FIG. 8 is a table showing process units and their process amounts before and after changing a dividing method of dividing the input program of FIG. 2, at Step e004 by the dividing unit 3 in the compiler system of FIG. 1;

FIG. 9 is a diagram showing an example of execution of the input program of FIG. 2 which is divided into process units at Step e004 by the dividing unit 3 in the compiler system of FIG. 1;

FIG. 10 is a flowchart of processing performed by a direction information generation unit 4 in the compiler system of FIG. 1;

FIG. 11 is a diagram showing an example of direction information which the direction information generation unit 4 in the compiler system of FIG. 1 generates for the input program 2;

FIG. 12 is a block diagram showing a structure of a compiler system when any requirement information is not received; and

FIG. 13 is a flowchart of processing performed by a dividing unit 3 in the compiler system of FIG. 12.

### DESCRIPTION OF THE PREFERRED EMBODIMENT(S)

The following describes a compiler system according to a preferred embodiment of the present invention with reference to the drawings.

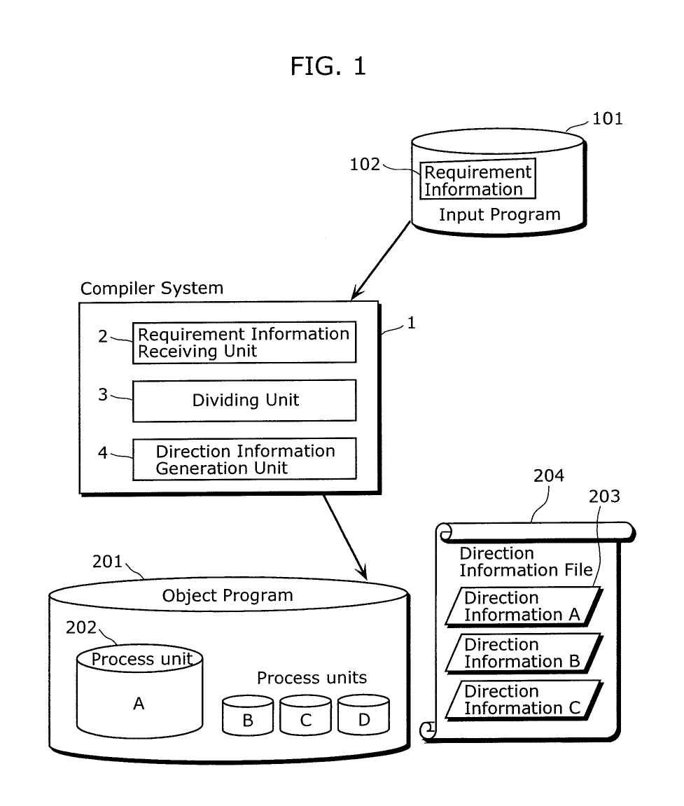

FIG. 1 is a block diagram showing a structure of a compiler system 1 according to the present invention.

The compiler system 1 includes a requirement information receiving unit 2, a dividing unit 3, and a direction information generation unit 4.

The requirement information receiving unit 2 is a receiving unit that receives requirement information 102 indicating required performance required on all or a part of an object program 201. Here, the requirement information 102 indicates requirements of performance to be allocated to process units to be executed in parallel. For example, the requirement information 102 includes at least one of: an upper limit of the number of cycles (hereinafter, as a “cycle number”) required to execute all or a part of the object program 201; an upper limit of a time period required to execute all or a part of the object program 201; an upper limit of the number of instructions (hereinafter, as an “instruction number”) for all or a part of the object program 201; an upper limit of a code size for all or a part of the object program 201; an upper limit of a rate of (i) processing performed to be allocated to all or part of the object program 201 to (ii) available performance of a processor system; an upper limit of a use amount of hardware resources used for all or a part of the object program 201; information for controlling a flow of executing all or a part of the object program 201; and the like.

The dividing unit 3 divides at least a part of an input program into a plurality of process units which can be executed in parallel. In more detail, the dividing unit 3 calculates a processing amount of each of one or more process units executable in parallel, and perform the above dividing to satisfy the required performance indicated by the requirement information 102. More particularly, the dividing unit 3 decides, in the input program, a plurality of to-be-divided parts which will be executable in parallel. Then, the dividing unit 3 calculates a processing amount of each of one or more to-be-divided parts. Next, the dividing unit 3 determines whether or not the calculated processing amount satisfies the required performance indicated by the requirement information 102. If the determination is made that the calculated processing amount satisfies the required performance, the dividing unit 3 divides at least a part of the input program into a plurality of process units that correspond to the to-be-divided parts. On the other hand, if the determination is made that the calculated processing amount does not satisfy the required performance, the dividing unit 3 changes the to-be-divided parts to other parts, and perform the above processing again from the calculation according to the new to-be-divided parts.

The direction information generation unit 4 is a generation unit that generates direction information directing a processor regarding processing performance to be allocated to one or more process units. Here, the direction information is at least one of: a cycle number required to execute all or a part of the process units; a time period required to execute all or a part of the process units; and a rate of (i) a processing amount required for all or a part of the process units to (ii) a processing amount required for available performance of the processor system. The direction information is interpreted by an operating system (OS) or a scheduler, and used to schedule the execution of all or a part of the process units. In FIG. 1, the direction information is generated and registered into a direction information file 204.

1. Requirement Information Receiving Unit 2

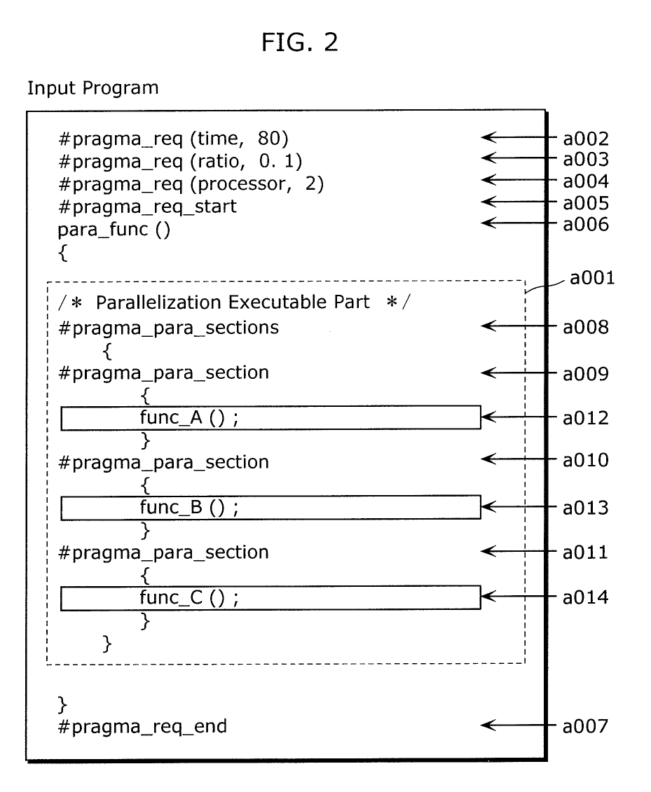

Here, an input program 101 is assumed to be described in C language as shown in FIG. 2. It should be noted, however, that the language and grammar of the input program 101 is not limited to the above in the present invention.

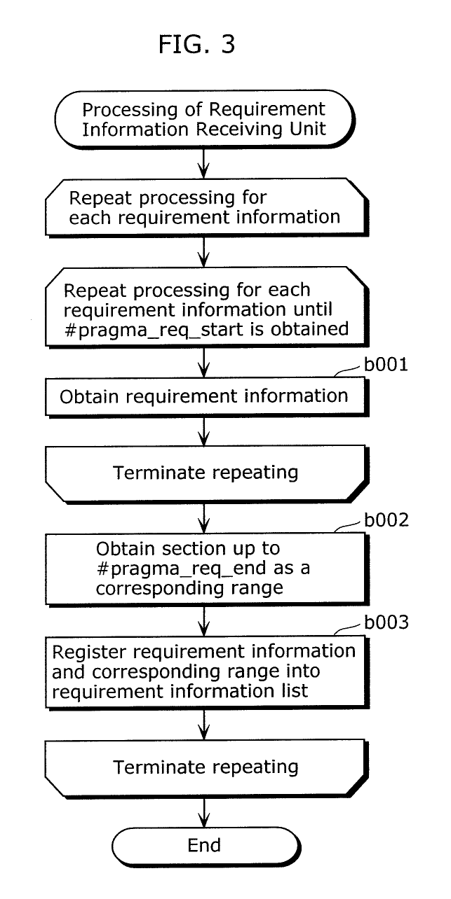

The following describes the processing performed by the requirement information receiving unit 2 to obtain requirement information 102 added to the input program 101, with reference to a flowchart of FIG. 3. The requirement information 102 is obtained by performing lexical analysis of the input program 101 and detecting predetermined reserved words. In the present invention, a method of the lexical analysis is not limited. In this example, it is assumed that “#pragma” indicates a directive statement directing a compiler of C language how to compile, that a reserved word “_req” indicates requirement information, and that reserved words “_req_start” and “_req_end” indicate a start statement and an end statement in a corresponding range corresponding to the requirement information, respectively. It is also assumed that, as reserved words indicating eight types of requirement information, “cycle” indicates an upper limit of cycles required for execution; “time” indicates an upper limit of a time [ms] required for the execution; “instruction” indicates an upper limit of instruction number for the execution; “size” indicates an upper limit of a code size [bit] for the execution; “ratio” indicates an upper limit of performance to be allocated to process units in the corresponding range of the requirement information in the case where available performance of the processor system is 1; “processor” indicates an upper limit of the number of used processors; “memory” indicates an upper limit of a use amount [bit] of a used memory; “path” indicates information for controlling a flow of the execution.

At Step b001, a statement described as “#pragma_req(type, numeral value)” is detected from the input program 101, the type and the numeral value in the statement are obtained as requirement information. The Step b001 is repeated until “#pragma_req_start” is obtained.

At Step b002, a section from “#pragma_req_start” to “#pragma_req_end” is obtained as a corresponding range corresponding to the obtained pieces of requirement information.

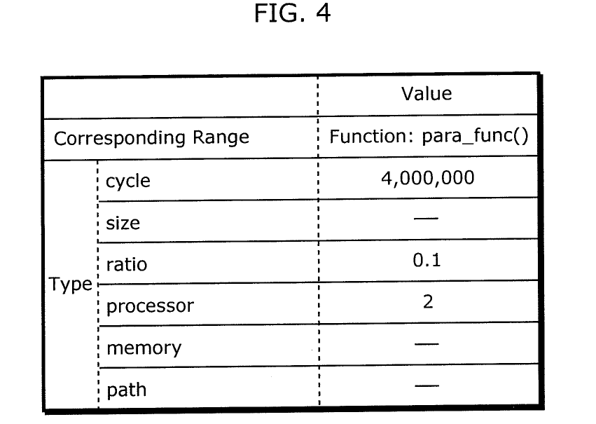

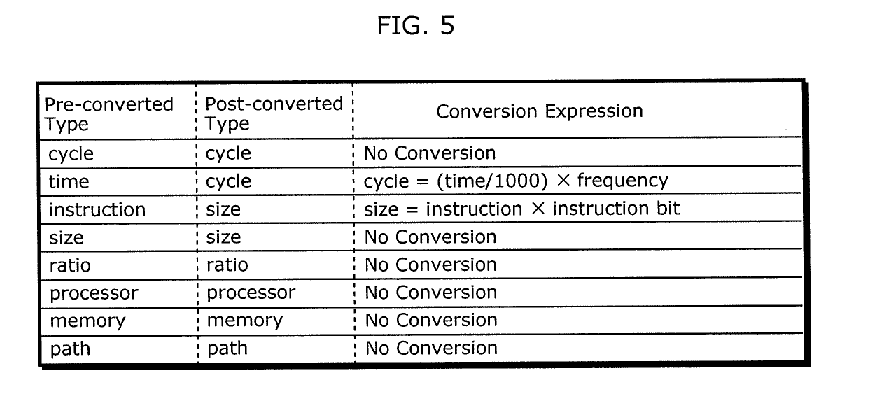

Next, at Step b003, the pieces of requirement information obtained at Step b001 and the corresponding range obtained at b002 are registered in a requirement information list as shown in FIG. 4. When registering, a conversion expression as shown in FIG. 5 is applied to each type of the requirement information, so that the requirement information is converted into information to be used in the dividing unit 3 as described later. Types to be converted are two of “time” and “instruction”. A conversion expression for each type is explained. A value of “time” is divided by 1000, and a unit is converted to a second. Then, the resulting value is multiplied by a value of a processor frequency “frequency” in the execution environment in order to be converted into “cycle”. If the input program 101 is added with both of “time” and “cycle”, one with a stricter requirement is registered to the requirement information list. A value of “instruction” is multiplied by a value of a bit length of one instruction “instruction bit”, to be converted to “size”. If the input program 101 is added with both of “instruction” and “size”, one with a stricter requirement is registered to the requirement information list. Such conversion reduces information held in the requirement information list, thereby reducing a use amount of a memory in the compiler system 1.

The above-described processing from Step b001 to Step b003 is repeated until an end statement of the input program 101 is processed, thereby creating a requirement information list for each corresponding range of requirement information.

An example of processing when the input program of FIG. 2 is received is described below.

At Step b001, a type “time” and a numeral value “80” are obtained from a statement a002 as requirement information a002; a type “ratio” and a numeral value “0.1” are obtained from a statement a003 as requirement information a003; and a type “processor” and a numeral value “2” are obtained from a statement a004 as requirement information a004.

At Step b002, a function described in a statement a006 “para_func( )” that is between a statement a005 “#pragma_req_start” and a statement 007 “#pragma_req_end” is obtained as an indication of a corresponding range.

At Step b003, the function “para_func( )” is registered as a corresponding range into a requirement information list. Subsequently, the requirement information a002, the requirement information a003, and the requirement information a004 are also registered into the requirement information list. A type of the requirement information a002 is “time”, so that the “time” is to be converted. Therefore, a value of “time” is divided by 1000, and the resulting value is multiplied by a value of a processor frequency “frequency” (here, 50 MHz) of execution environment, to be a value “4,000,000” which is registered as “cycle”. The types of the requirement information a003 and the requirement information a004 are “ratio” and “processor”, respectively, for which conversion is not necessary. Therefore, “0.1” is registered for “ratio”, and “2” is registered for “processor”, respectively.

In the input program 101 of FIG. 2, there is no corresponding range of the requirement information except the above range. Therefore, the processing of the requirement information receiving unit 2 is now completed.

It should be noted that the processor and the memory are described as used hardware resources, but hardware resources are not limited to them.

It should also be noted that, in the above example of the input program of FIG. 2, the requirement information is described in the input program using “#pragma”, but requirement information and a corresponding range of the requirement information may be described in a requirement information file different from the input program. In such a case, the requirement information receiving unit 2 may receives the input program and the requirement information file, and perform general lexical analysis on the input program and registers data of the requirement information file to a requirement information list. The separation of files can prevent the input program from being rewritten, thereby increasing reusability of the input program. However, there is also a drawback of complicated structure management due to a plurality of files.

It should also be noted that the number of types in a requirement information list may be increased to eight at Step b003, and these types may be directly registered without conversion depending on the types. In this case, the conversion can be performed by the dividing unit 3 described later. However, the increase of types increases pieces of requirement information in the requirement information list, thereby increasing a use amount of the memory in the compiler system 1.

It should also be noted that, if at Step b003 a bit length of one instruction is not fixed but variable, “instruction” cannot be converted to “size” when obtaining the requirement information. In this case, an item of “instruction” is added to a requirement information list, and the “instruction” is converted to “size” after deciding an instruction sequence of a corresponding range of the requirement information.

It should also be noted that in FIG. 4 the requirement information list has six items as types, the items may be increased or decreased depending on which types the compiler system 1 can receive as requirement information. This makes it flexible to manage types even if a new type of requirement information is added. It should also be note that the number of items of types can be variable and that the items can be decided depending on types of received requirement information. This can eliminate items of types which are not received, thereby reducing a use amount of the memory of the compiler system 1.

2. Dividing Unit 3

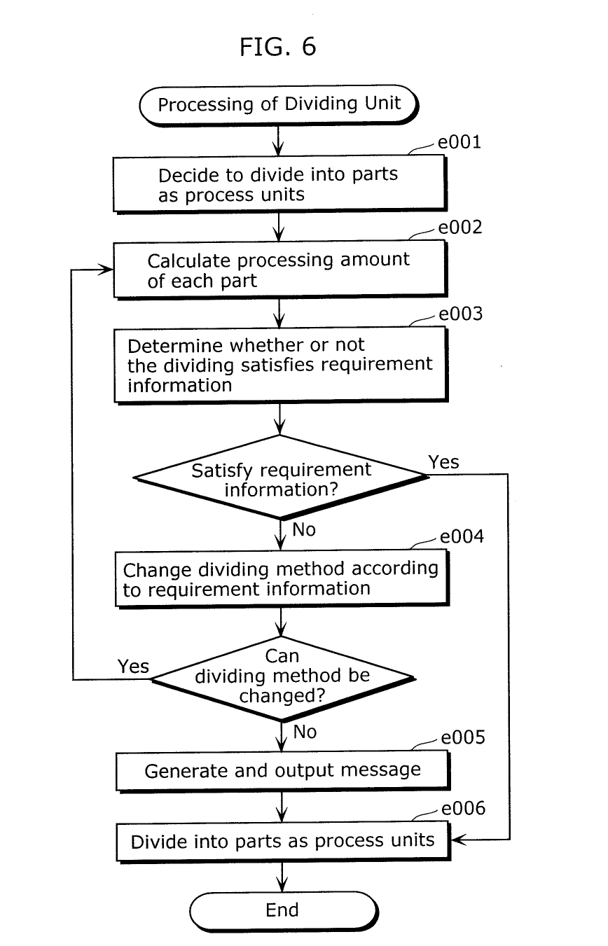

The processing performed by the dividing unit 3 to divide a parallelization executable part into a plurality of process units is described with reference to a flowchart of FIG. 6.

At Step e001, the dividing unit 3 decides a parallelization executable part in the input program 101 to be to-be-divided into process units. The decision of the parallelization executable part is achieved by detecting a parallelization executable part designated in the input program, or by automatically detecting a parallelization executable part, in the same manner as the conventional parallel compilers. In the present invention, the method of deciding a parallelization executable part is not limited. At Step e001, the dividing unit 3 have not yet divided the parallelization executable part into process units. The dividing is performed later at Step e006. At Steps e002 to e005, each processing is performed under the assumption that the parallelization executable part has been divided into process units.

At Step e002, a processing amount of each of to-be-divided process units which have been decided at Step e001 to be generated by dividing the parallelization executable part is calculated. The processing amount is the number of cycles (cycle number) required to execute the corresponding to-be-divided process unit. The processing amount of the to-be-divided process unit can be calculated using an ideal cycle number of the to-be-divided process unit and an overhead of parallelization. The ideal cycle number is the number of cycles calculated using an instruction sequence in the to-be-divided process unit and the number of cycles required for each instruction. Processing required to execute parallelization added to execution of the to-be-divided process unit is a predetermined processing such as generation/release of the to-be-divided process unit, synchronization between to-be-divided process units, and the like. Therefore, a cycle number required for the overhead of parallelization is reserved in the compiler system 1, and the cycle number is added to the cycle number of the to-be-divided process unit when calculating the processing amount.

If a flow of controlling the to-be-divided process unit depends on a variable having a value that will be decided in actually executing the object program 201, the above-described method fails the calculation of a processing amount. In such a case, a processing amount can be calculated using profile information of the object program 201 or hint information added to the input program 101.

Firstly, a method of calculating a processing amount by using profile information is described. The profile information is generated by executing an object program in actual execution environment or in simulation. In the present invention, a method of generating a profile information is not limited. If profile information is available, a processing amount of each to-be-divided process unit is obtained at Step e002 from the profile information.

Next, a method of calculating a processing amount by using hint information is described. The hint information is information which a programmer knows without executing the object program. In the present invention, a method of describing the hint information is not limited. The “#pragma” may be used as hint information. If the hint information is a cycle number required to execute a part or all of to-be-divided process units, an ideal cycle number regarding a part in which no cycle number is described is calculated, and then the ideal cycle number is used to calculate a processing amount of the to-be-divided process unit. If the hint information is a rate of (i) a processing amount of a part or all of to-be-divided process units to (ii) a processing amount of the object program 201, the processing amount of the object program 201 is calculated using the processing amount of a part or all of to-be-divided process units. If the hint information is a value of a variable in a to-be-divided process unit and will be decided in executing the object program, an ideal cycle number of the to-be-divided process unit is calculated using the value.

At Step e003, it is determined whether or not the object program 201 satisfies the requirement information 102 added to the input program 101 when the parallelization executable part is divided into process units. A method of the determination is described below.

Firstly, it is determined whether or not a part or all of execution of the to-be-divided process units is included within the corresponding range registered in the requirement information list. If the determination is made that the part or all of the execution is included within the corresponding range, it is then determined whether or not each type of the requirement information satisfies the corresponding request. In more detail, if a type of the requirement information is “cycle”, it is determined whether or not the “cycle” satisfies the requirement information, using a processing amount of the corresponding to-be-divided process unit. If a type of the requirement information is “size”, it is determined whether or not the “size” satisfies the requirement information, by calculating a size from an instruction number in the to-be-divided process unit and a bit length of each instruction. If a type of the requirement information is “ratio”, it is determined whether or not a processing amount of the to-be-divided process unit can be executed within performance allocated to the to-be-divided process unit. If a type of the requirement information is “processor”, it is determined whether or not the “processor” satisfies the requirement information, by comparing the number of the to-be-divided process units to a value of the “processor”. If a type of the requirement information is “memory”, it is determined whether or not the “memory” satisfies the requirement information, by calculating a use amount of a memory used for the to-be-divided process unit. If a type of the requirement information is “path”, it is determined whether or not the “path” satisfies other requirement information, in the case where the process units satisfy an execution flow designated by the “path”. The above-described determination is repeated for each of the to-be-divided process units and the requirement information list.

If it is determined at Step e003 that the object program 201 satisfies the requirement information 102, then Step e006 is performed. Otherwise, Step e004 is performed.

At Step e004, the method of dividing the parallelization executable part (hereinafter, referred to as a “dividing method”) is changed depending on the requirement information that has not been satisfied. If a type of the requirement information that has not been satisfied is “cycle”, a processing amount per process unit is decreased by increasing the number of process units to be executed in parallel. If a type of the requirement information that has not been satisfied is “size”, a code size is reduced, by reducing the number of the to-be-divided process units thereby reducing executions required for parallelization added to the executions of the to-be-divided process units. If a type of the requirement information that has not been satisfied is “ratio”, a processing amount per process unit is decreased by increasing the number of process units to be executed in parallel, in the same manner as described for the “cycle”. If a type of the requirement information that has not been satisfied is “processor”, the number of process units to be executed in parallel is decreased. If a type of the requirement information that has not been satisfied is “memory”, a use amount of a memory to be used for each to-be-divided process unit, by reducing the number of the to-be-divided process units, in the same manner as described for the “size”.

If the dividing method can be changed at Step e004, the processing returns to Step e002 to calculate a processing amount again and, at Step e003, determine whether or not the requirement information is satisfied. On the other hand, if the dividing method cannot be changed, Step e005 is performed. When the repeating Steps e002 to e004 results in the dividing method that has been once performed, or incoherence and unsatisfactory of the requirement information, Step e005 is performed.

At Step e005, a message is generated for the requirement information that has not been satisfied, and then outputted. This message enables the programmer to easily specify requirement information to be revised.

At Step e006, the parallelization executable part is divided into process units. A method of dividing the parallelization executable part into process units is not limited. The method may be the same as the method in the conventional parallelization compilers.

An example of processing when the input program of FIG. 2 is received is described below.

Here, it is assumed that the “#pragma” is used, that “_para_sections” is a reserved word indicating a designation of a parallelization executable part, and that a section from “{” following a detected statement “#pragma_para_sections” to a corresponding “}” is a parallelization executable part. It is also assumed that “_para_section” is a reserved word indicating a to-be-divided part in the parallelization executable part, and that a section from “{” following a detected statement “#pragma_para_section” to a corresponding “}” is the to-be-divided part.

At Step e001, a001 ranging from “{” following a statement a008 “#pragma_para_sections” to a corresponding “}” is detected as a parallelization executable part. Next, each section from “{” following a statement a009, a010, or a011 “#pragma_para_section” to a corresponding “}” is detected as a to-be-divided part a012, a013, or a014. Subsequently, each of the detected to-be-divided parts a012, a013, and a014 is decided to be a part to be divided, as a process unit, from the parallelization executable part.

At Step e002, a processing amount of each of the to-be-divided parts a012, a013, and a014 which have been decided at Step e001 as the parts to be divided as process units from the input program. Here, it is assumed that an overhead of parallelization is “100,000 cycles”, that an ideal cycle number of a012 is “2,400,000 cycles”, that an ideal cycle number of a013 is “1,700,000 cycles”, and that an ideal cycle number of a014 is “1,100,000 cycles”. It is also assumed that an ideal cycle number of an sequential execution partrequirement information is “500,000 cycles”. Here, the sequential execution part is a part obtained by eliminating the parallelization executable part a001 from “para_func( )” of a006 as a corresponding range of the requirement information.

At Step e003, it is determined whether or not a012, a013, and a014 are included in a corresponding range of a requirement information list. Since a012, a013, and a014 are included in “para_func( )” of a006 that is a corresponding range of requirement information, it is determined whether or not the “para_func( )” satisfies a requirement after the to-be-divided part in the parallelization executable part a001 are divided as process units.

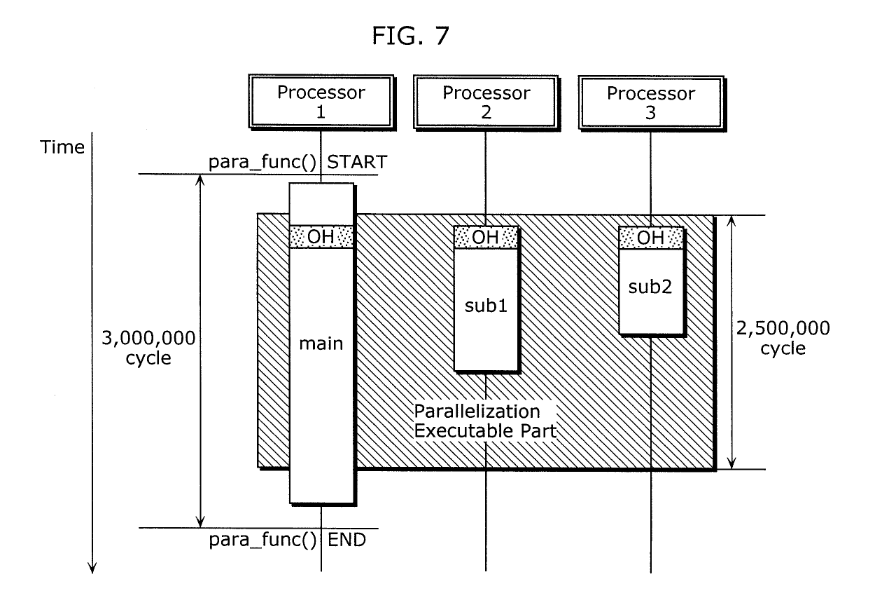

FIG. 7 shows an example of execution of “para_func( )” after dividing the to-be-divided part in the parallelization executable part a001 as process units. “main” is a process unit that is combination of sequential execution parts before and after the parallelization executable part of “para_func( )” and a012. “sub1” and “sub2” are obtained when a013 and a014 are divided as process units. “OH” is an overhead of parallelization. Execution of “para_func( )” is started by “processor 1”. When the parallelization executable part is to be executed, the process units “sub1” and “sub2” are invoked by “processor 2” and “processor 3”, respectively. Thereby, “main”, “sub1”, and “sub2” are executed in parallel. After completion of the execution of the parallelization executable part, “processor 1” executes remained sequential execution part in “main”.

It is known, from the processing amounts calculated at Step e002, that processing amounts of “main”, “sub2” and “sub3” are “2,500,000 cycles”, “1,800,000 cycles”, and “1,200,000 cycles”, respectively. Since the processing amount of the sequential execution part in “main” is “500,000 cycles”, a processing amount of the entire “para_func( )” is “3,000,000 cycles”. Requirement information for “para_func( )” is “cycle” with a value “4,000,000”, “ratio” with a value “0.1”, and “processor” with a value “2”. Therefore, the processing amount of the entire “para_func( )” is “3,000,000 cycles” which satisfies a requirement on “cycle”. Here, the usable performance of the system is assumed to be “50 MHz” as the same as the processor frequency “frequency”. Since “ratio” is “0.1”, performance allocated to each processor is “5 MHz”, which means “5,000,000 cycles” per 1 second. Since a processing amount of the process units “main”, “sub1”, and “sub2” is within “5,000,000 cycles”, the processing amount satisfies a requirement on “ratio”. Division of process units “main”, “sub1”, and “sub2” at Step e001 results in need of three processors. This does not satisfy a requirement on “processor”. Since the requirement information is not satisfied, Step e004 is performed.

At Step e004, a method of dividing the input program into process units is changed to satisfy the requirement on “processor” which has not been satisfied at Step e003. Since the requirement on “processor” is “2”, the method is changed to divide the input program into two process units. Therefore, “sub1” and “sub2” which have small processing amounts are combined to be a single process unit “sub”. Since the method of dividing can be changed, Step e002 is performed again.

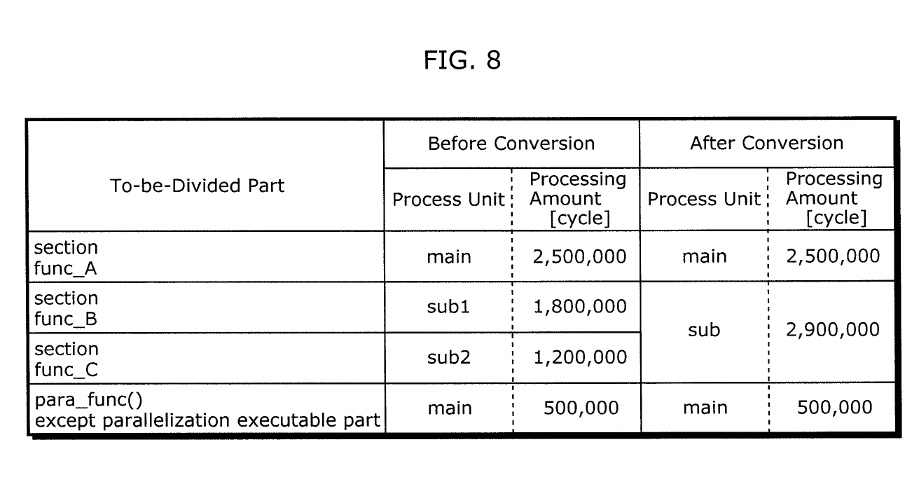

At the second Step e002, a processing amount of the process unit “sub” which is created at Step e004. FIG. 8 shows processing amounts before and after changing the method of dividing. A processing amount of the process unit “sub” is “2,900,000 cycles” that is calculated by adding the ideal cycle numbers of a013 and a014 with the overhead of parallelization.

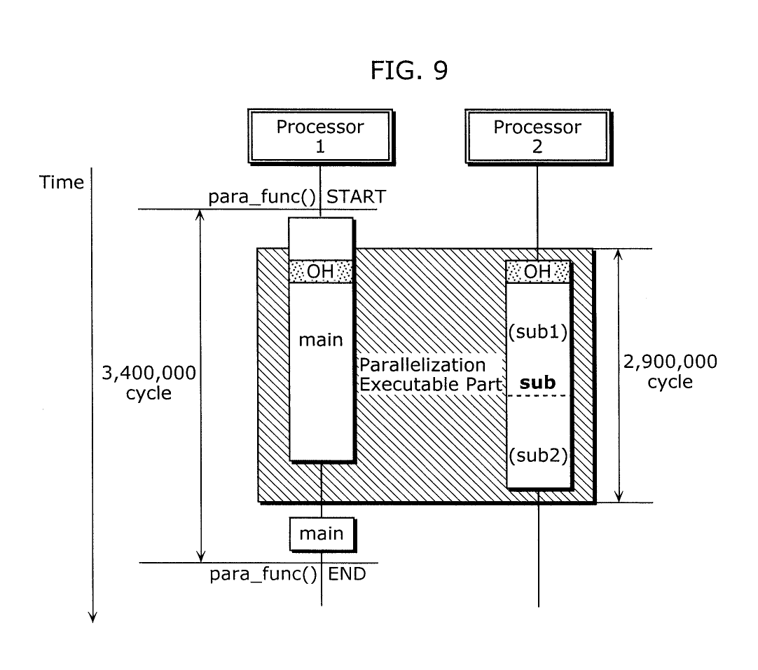

At the second Step e003, it is determined whether nor not “para_func( )” after changing the method of dividing satisfies the requirement information. FIG. 9 shows an example of execution of “para_func( )” after changing the method of dividing. Since the method of dividing has been changed, a processing amount of the entire “para_func( )” becomes “3,400,000 cycles”. This satisfies the requirement on “cycle”. Next, since a processing amount of the process units “main” and “sub” is within “5,000,000 cycles”, the processing amount satisfies the requirement on “ratio”. Since the process units are two of “main” and “sub”, the process units satisfies a requirement on “processor”. Since the process units satisfies the requirement, Steps e006 is performed.

At Step e006, the input program is divided so that the sequential execution part in “para_func( )” and a012 become a process unit “main”, and a013 and a014 becomes a process unit “sub”.

Thus, the processing performed by the dividing unit 3 to divide the parallelization executable part into a plurality of process units is completed.

It should be noted that it has been described in the above description that the dividing of the input program into process units is performed at Step e006, but the dividing may be performed every time the to-be-divided part is decided at Step e004. However, the above case has a drawback of additional processing if the input program needs to be back to a state before the dividing when the method of dividing is to be changed. Although the dividing is possible while maintaining a state before the dividing, there is a drawback of increase of a use amount of a memory for each change of the method of dividing.

3. Direction Information Generation Unit 4

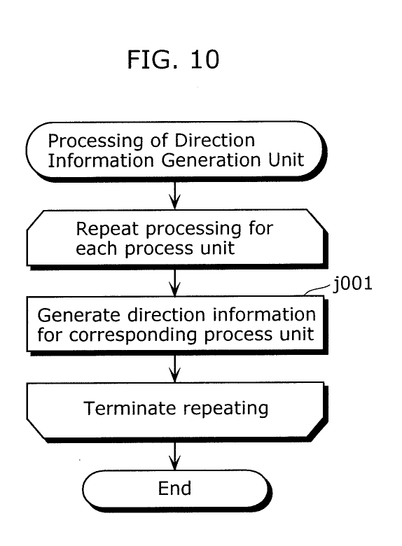

The processing performed by the direction information generation unit 4 to generate direction information for each process unit is described with reference to a flowchart of FIG. 10. Here, it is assumed that pieces of direction information for all process units are generated and registered into a direction information file different from the object program.

At Step j001, direction information is generated for each of the process units in the object program. The generated direction information has a name of the corresponding process unit and, for example, a processing amount of the corresponding process unit calculated at Step e002 by the dividing unit 3.

An operating system or a hardware scheduler interprets the direction information in the direction information file to be a relative priority, and performs scheduling of the object program to assure processing performance.

An example of processing when the input program of FIG. 2 is received is described below.

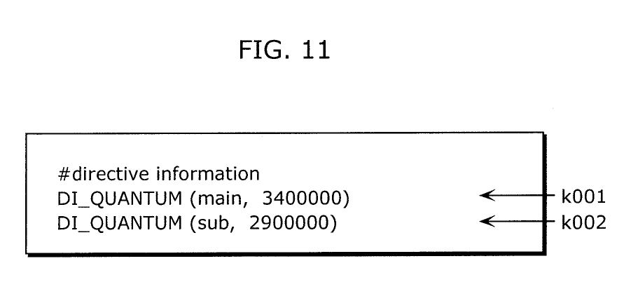

FIG. 11 shows a direction information file generated by the direction information generation unit 4 when the input program of FIG. 2 is received. Here, a format of the direction information is assumed to be “DI_QUANTUM(name of processing unit, direction information body)” to be outputted.

At Step j001, firstly, direction information is generated for a process unit “main” in the object program. Since a processing amount of the process unit “main” is “3,400,000 cycles”, the direction information is generated as “DI_QUANTUM(main, 3400000)” as shown as k001 in FIG. 11. Subsequently, another direction information is generated for a process unit “sub”. Since a processing amount of the process unit “sub” is “2,900,000 cycles”, the direction information is generated as “DI_QUANTUM(sub, 2900000)” as shown as k002 in FIG. 11.

Thus, the processing performed by the direction information generation unit 4 to generate direction information for each processing unit is completed.

It should be noted that it has been described that pieces of direction information for all process units are generated and registered into a direction information file different from the object program, but the method of the generation is not limited to the above in the present invention. For example, the pieces of direction information may be registered separately to different direction information files corresponding to respective process units. Or, the pieces of direction information may be registered to the object program, not to the direction information file. In the case where the pieces of direction information are registered to the object program, they may be registered together or separately for each process unit.

It should also be noted that it has been described that the direction information is generated for each of all process units, but if a processing amount of a certain process unit cannot be calculated, it is also possible to generate direction information for each of a part of the process units.

It should also be noted that a cycle number has been used as the direction information in the above example, but the direction information may be a value indicating a time period required to execute the corresponding process unit. In such a case, such a time period can be calculated using an equation of time period [ms]=(cycle number/processor frequency)*1000.

It should also be noted that a cycle number has been used as the direction information in the above example, but the direction information may be a cycle number per unit time required to execute the corresponding process unit. In such a case, such a cycle number per unit time can be calculated using an equation of cycle number per unit time=cycle number*(1/unit time).

It should also be noted that a cycle number has been used as the direction information in the above example, but the direction information may be a value of a time period per unit time required to execute the corresponding process unit. In such a case, such a time period per unit time can be calculated using an equation of a time period per unit time [ms]=(cycle number/processor frequency)*1000*(1/unit time).

It should also be noted that a cycle number has been used as the direction information in the above example, but the direction information may be a ratio of (i) a processing amount of the corresponding process unit to (ii) a processing amount of the entire object program.

It should also be noted that a cycle number has been used as the direction information in the above example, but the direction information may be a ratio of (i) a processing amount of the corresponding process unit to (ii) a possible processing amount of the object program in execution environment.

It should also be noted that a cycle number has been used as the direction information in the above example, but the direction information may be a value representing a priority assigned to the corresponding process unit. The value of priority can be set so that a process unit with a more processing amount has a higher priority.

It should also be noted that it has been described that an operating system or a hardware scheduler uses the direction information as a relative priority for a corresponding process unit, assuming that the direction information uniquely decides the relative priority, but the direction information may be a reference value used to decide the relative priority. In other words, a programmer can modify the direction information depending on an execution state of the object program, or change the direction information to be easily used by the operating system or the hardware scheduler.

Although only an exemplary embodiment of the compiler system and their elements according to the present invention has been described in detail above, those skilled in the art will be readily appreciate that many modifications are possible in the exemplary embodiment without materially departing from the novel teachings and advantages of the present invention. Accordingly, all such modifications are intended to be included within the scope of the present invention. Examples of the modifications are as follows.

(1) It has been described in the above embodiment that the compiler system according to the present invention is for C language, but the programming language is not limited to C language. Any other programming languages can be used to achieve the effects and advantages of the present invention.

(2) It has been described in the above embodiment that the present invention is comprised of the compiler system only, but the structure of the present invention is not limited to the above. For example, the present invention may be separated to more elements/sub-tools.

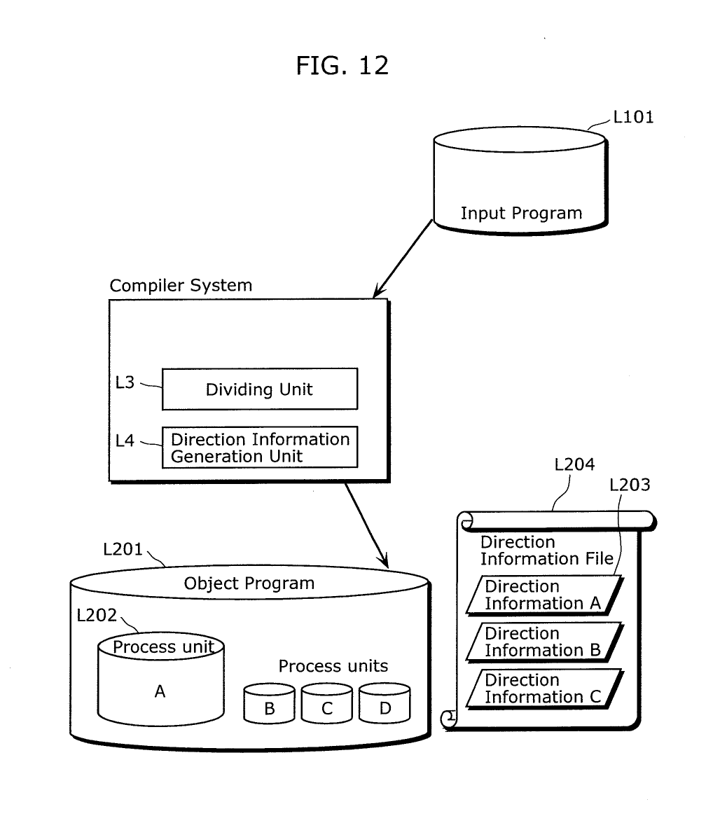

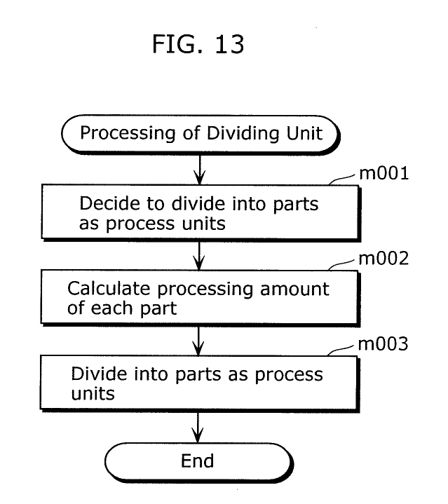

(3) It has been described in the above embodiment that requirement information is previously added to an input program, but direction information may be generated for an input program without any requirement information when the input program is to be divided to process units. In such a case, the requirement information 102 and the requirement information receiving unit 2 in FIG. 1 are not necessary, and a compiler system L1 as shown in FIG. 12 receives an input program L101 without any requirement information and a dividing unit L3 divides the input program L101 into process units. A flow of processing performed by the dividing unit L3 is shown in FIG. 13. At Step m001, the dividing unit L3 decides parts to be divided into process units. At Step m002, a processing amount of each to-be-divided process unit is calculated. At Step m003, the input program L101 are divided in to the to-be-divided parts as process units, and the processing is completed. A direction information generation unit L4 sets the processing amount calculated by the dividing unit L3 to be direction information L203, and registers the direction information L203 to a direction information file, in the same manner as the direction information generation unit 4 of FIG. 1.

### INDUSTRIAL APPLICABILITY

The present invention can be used as a compiler system that coverts a source program described in C language or assembly language to a program described in machine language.

What is claimed is:

1. A program converting device that converts an input program to an object program, said program converting device comprising:
a dividing unit configured to divide at least a part of the input program into a plurality of process units which are executable in parallel; and
a generation unit configured to generate direction information that directs, to a processor, processing performance to be allocated to at least one of the plurality of process units.

2. The program converting device according to claim 1,
wherein said dividing unit is configured to calculate a processing amount of each of at least one of the plurality of process units, and
said generation unit is configured to generate the direction information using the processing amount calculated by said dividing unit.

3. The program converting device according to claim 1, further comprising
a receiving unit configured to receive requirement information that indicates required performance required on all or a part of the object program,
wherein said dividing unit is configured to perform the dividing to satisfy the required performance indicated by the requirement information.

4. The program converting device according to claim 3,
where said dividing unit includes:
a decision unit configured to decide a plurality of to-be-divided parts in the input program, the plurality of to-be-divided parts being executable in parallel;
a calculation unit configured to calculate a processing amount of each of at least one of the plurality of to-be-divided parts;
a determination unit configured to determine whether or not the processing amount calculated by said calculation unit satisfies the required performance indicated by the requirement information; and
a dividing processing unit configured to divide the at least the part of the input program into the to-be-divided parts as the plurality of process units, when said determination unit determines that the processing amount satisfies the required performance,
wherein said decision unit is configured to change the to-be-divided parts, when said determination unit determines that the processing amount does not satisfy the required performance.

5. The program converting device according to claim 2,
wherein said dividing unit is configured to calculate the processing amount including an overhead resulting from the dividing to the plurality of process units.

6. The program converting device according to claim 2,
wherein said dividing unit is configured to calculate the processing amount using profile information added to the input program.

7. The program converting device according to claim 2,
wherein said dividing unit is configured to calculate the processing amount using hint information added to the input program.

8. The program converting device according to claim 2,
wherein the hint information is regarding the number of cycles required to execute all or a part of the plurality of process units.

9. The program converting device according to claim 2,
wherein the hint information is regarding a rate of (i) a processing amount of all or a part of the plurality of process units to (ii) a processing amount of all of the object program.

10. The program converting device according to claim 2,
wherein the hint information is regarding a value of a variable described in the input program, the value being decided in executing the object program.

11. The program converting device according to claim 4,
wherein said decision unit is configured to, when the change of the to-be-divided parts is impossible, generate and output a message notifying the impossibility.

12. The program converting device according to claim 2,
wherein the direction information is regarding the number of cycles required to execute all or a part of the plurality of process units.

13. The program converting device according to claim 2,
wherein the direction information is regarding a time period required to execute all or a part of the plurality of process units.

14. The program converting device according to claim 2,
wherein the direction information is regarding a ratio of (i) a processing amount of all or a part of the plurality of process units to (ii) a processing amount of the object program.

15. The program converting device according to claim 2,
wherein the direction information is regarding a priority assigned to each of all or a part of the plurality of process units.

16. The program converting device according to claim 2,
wherein the direction information is regarding a processing amount to be allocated to all or a part of the plurality of process units.

17. The program converting device according to claim 2,
wherein said generation unit is configured to generate the direction information as a file.

18. The program converting device according to claim 2,
wherein said generation unit is configured to generate the direction information to be a part of the object program.

19. The program converting device according to claim 2,
wherein the requirement information is a requirement for performance on at least two of the plurality of process units.

20. The program converting device according to claim 2,
wherein the requirement information is regarding an upper limit of the number of cycles required to execute all or a part of the object program.

21. The program converting device according to claim 2,
wherein the requirement information is regarding an upper limit of a time period required to execute all or a part of the object program.

22. The program converting device according to claim 2,
wherein the requirement information is regarding an upper limit of the number of instructions for executing all or a part of the object program.

23. The program converting device according to claim 2,
wherein the requirement information is regarding an upper limit of a code size for executing all or a part of the object program.

24. The program converting device according to claim 2,
wherein the requirement information is regarding an upper limit of a ratio of (i) the processing performance to be allocated to all or a part of the plurality of process units to (ii) processing performance required for the object program.

25. The program converting device according to claim 2,
wherein the requirement information is regarding an upper limit of a use amount of a hardware resource used for all or the part of the object program.

26. The program converting device according to claim 2,
wherein the requirement information is regarding information for controlling a flow of executing all or a part of the object program.

27. A program converting method of converting an input program to an object program, said program converting method comprising:
dividing at least a part of the input program into a plurality of process units which are executable in parallel; and
generating direction information that directs, to a processor, processing performance to be allocated to at least one of the process units.

28. A computer program, recorded on a computer-readable recording medium, for converting an input program to an object program, said computer program causing a computer to execute at least:
dividing at least a part of the input program into a plurality of process units which are executable in parallel; and
generating direction information that directs, to a processor, processing performance to be allocated to at least one of the process units.

29. A computer-readable recording medium on which a computer program for converting an input program to an object program is embodied, the computer program causing a computer to execute at least:
dividing at least a part of the input program into a plurality of process units which are executable in parallel; and
generating direction information that directs, to a processor, processing performance to be allocated to at least one of the process units.
